(19) United States
(12) Patent Application Publication
(10) Pub. No.: US 2008/0141308 A1
(43) Pub. Date: Jun. 12, 2008

(54) Apparatus And Method For Providing Adaptive Broadcast Service Using Usage Environment Description Including Biographic Information And Terminal Information

(76) Inventors: Kyoung-Ro Yoon, Seoul (KR); Sun-Young Han, Seoul (KR); Hee-Kyung Lee, Daejeon (KR); Jung-Won Kang, Seoul (KR); Jae-Gon Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/813,383

(22) PCT Filed: Jan. 6, 2006
(86) PCT No.: PCT/KR06/00059

§ 371 Date: Sep. 26, 2007

(30) Foreign Application Priority Data
Jan. 7, 2005 (KR) 10-2005-0001878

(51) Int. Cl. G06F 3/00; H04N 7/173

(52) U.S. Cl. 725/46; 725/114

(57) ABSTRACT

Provided is an adaptive broadcasting service providing apparatus using UED information including biographic information and terminal information. The apparatus can provide a targeting function for selecting AV program, package or components of the package based on a user consumption environment and preference by defining biographic information and terminal information for describing characteristic information for personal biographic information and terminal information, and adding the biographic information and terminal information to the UED information. The apparatus includes: a contents providing unit for publishing and providing the broadcasting contents and metadata including the UED information to the user terminal; and a contents searching unit for providing contents identification information upon a search and selection signal from the user terminal, wherein the UED information describes a consumption environment of the contents and includes: biographic information for describing characteristics of user's biographic information; and terminal information for describing characteristic information of the user terminal.

### TECHNICAL FIELD

The present invention relates to an apparatus and method for providing an adaptive broadcasting service using Usage Environment Description (UED) information; and, more particularly, to an adaptive broadcasting service providing apparatus using UED information including biographic information and terminal information to provide a targeting function in an adaptive broadcasting system such as a TV-Anytime (TVA) system, and a method thereof.

### BACKGROUND ART

As broadcasting is digitalized, broadcasting environments are rapidly changing from conventional unidirectional broadcasting into complex forms such as accommodation of diverse reception terminals through a linkage between a broadcasting network and a communication network as well as multimedia and multi-channels. Also, increasing number of viewers who used to inactively receive broadcasting programs in a limited range of channels, want to directly participate in a broadcasting service or receive/watch desired programs at desired time.

It can be summarized that the broadcasting environments evolve into complexly and diversely personalized forms. In the complex, diverse and new broadcasting environments, an adaptive broadcasting makes it possible that the viewers conveniently and efficiently consume desired broadcasting contents in forms which fit to the preferences of the viewers at desired time with diverse terminals. That is, the adaptive broadcasting provides adaptive broadcasting contents, which fit to a usage environment including user preference, terminal performance, network characteristics and a natural environment such as time, place and user's feeling.

The TV-Anytime forum is a group for defining a standard for the adaptive broadcasting. The TV-Anytime forum is a private standard organization established in September 1999 to establish a standard for providing services related to audio and visual in a user environment having a Personal Digital Recorder (PDR).

The standard for the adaptive broadcasting in the TV-Anytime forum is divided into a Phase 1, i.e., TVA-1 and a Phase 2, i.e., TVA-2 in the respect of an assumed system environment and major functions to be provided.

The TVA-1 provides application services such as search, selection, acquisition and consumption of audio/video (AV) contents based on Personal Digital Recorder (PDR) in an environment where a main broadcasting program is transmitted through a unidirectional broadcasting channel and additional metadata can be acquired through a bi-directional network.

The metadata means descriptive data for contents such as a program title, genre and overview, and they are generally defined as data about data.

The TVA-2 extends the consumption environment of the TVA-1 assuming the unidirectional broadcasting channel and the bi-directional network. It provides a package, which can be identified and acquired as one selection unit, by integrating media components having diverse forms such as an application program, an advertisement, an image, a text as well as an AV program, which is an important service object of the TVA-1 in a home network environment.

The package describes information on the package and its components, and provides a targeting function for selecting components from the package based on a consumption environment and user preference and a synchronizing function for accurate consumption through description on temporal/spatial relationship.

Also, the TVA system provides a targeting function for selecting the provided AV program, package, components of the package according to the consumption environment and the user preference.

Herein, it is required to minutely and clearly define and use the description information for describing usage environment such as terminal characteristic information or user characteristic information in detail to efficiently provide the targeting function.

### DISCLOSURE

### Technical Problem

It is, therefore, an object of the present invention to provide an adaptive broadcasting service providing apparatus which can provide an advanced targeting function for selecting Audio/video (AV) program, package or components of the package based on a user consumption environment and preference by defining biographic and terminal information for describing characteristic information for personal biographic information and terminal information, and adding the biographic and terminal information to Usage Environment Description (UED) information.

Other objects and advantages of the invention will be understood by the following description and become more apparent from the embodiments in accordance with the present invention, which is set forth hereinafter. It will be also apparent that objects and aspects of the invention can be embodied easily by the means defined in the claims and combinations thereof.

### Technical Solution

In accordance with one aspect of the present invention, there is provided an adaptive broadcasting service providing apparatus using Usage Environment Description (UED) information and providing a targeting function for selecting an audio/video (AV) program, a package or components of the package based on a consumption environment and user preference, in an adaptive broadcasting system for providing broadcasting contents including AV programs and packages to a user terminal, the apparatus including: a contents providing unit for publishing and providing the broadcasting contents and metadata including the UED information to the user terminal; and a contents searching unit for providing contents identification information corresponding to a search and selection signal inputted from the user terminal, wherein the UED information describes a consumption environment of the contents and includes: biographic information for describing characteristics of user's biographic information; and terminal information for describing characteristic information of the user terminal.

In accordance with another aspect of the present invention, there is provided an adaptive broadcasting service providing method using UED information and providing a targeting function for selecting an AV program, a package or components of the package based on a user consumption environment and preference, in an adaptive broadcasting system for providing broadcasting contents including AV programs and packages to a user terminal, including the steps of: a) publishing metadata including the broadcasting contents and the UED information to the user terminal; b) providing contents identification information corresponding to a search and selection signal transmitted from the user terminal; c) determining physical location of the broadcasting contents based on the contents identification information and providing location information; and d) providing the broadcasting contents based on the location information, wherein the UED information describes a consumption environment of the contents and includes: biographic information for describing characteristics of user's biographic information; and terminal information for describing characteristic information of the user terminal.

In accordance with another aspect of the present invention, there is provided an adaptive broadcasting system using UED information, the system including: an adaptive broadcasting service providing apparatus for providing broadcasting contents including AV program and a package, and an adaptive broadcasting service supporting a synchronizing function and a targeting functions based on UED information; and a user terminal for receiving and consuming broadcasting contents and metadata from the adaptive broadcasting service providing apparatus, wherein the UED information describes a consumption environment of the contents and includes: biographic information for describing characteristics of user's biographic information; and terminal information for describing characteristic information of the user terminal.

In accordance with another aspect of the present invention, there is provided a user terminal for receiving broadcasting contents including an AV program and a package based on UED in an adaptive broadcasting system for providing an adaptive broadcasting service supporting a synchronizing function and a targeting function from an adaptive broadcasting service providing apparatus to the user terminal, including: a user interaction unit for searching, selecting and acquiring the broadcasting contents based on metadata including the UED information published from the adaptive broadcasting service providing apparatus; a local storage managing unit for storing and managing the acquired broadcasting contents and metadata; and a contents presenting unit for presenting the broadcasting contents and the metadata such that a user can watch, wherein the UED information describes a consumption environment of the contents and includes: biographic information for describing a characteristic of user's biographic information; and terminal information for describing characteristic information of the terminal.

In accordance with another aspect of the present invention, there is provided a metadata scheme, including: UED information for a TV-Anytime (TVA) broadcasting service, wherein the UED information includes: biographic information for describing a characteristic of user's biographic information; and terminal information for describing characteristic information of the user terminal.

### ADVANTAGEOUS EFFECTS

The present invention can provide an audio/video (AV) program, package or components of the package adaptively to diverse consumption environment and user preferences by improving description on usage environment of biographic and terminal information in an adaptive broadcasting system such as a TV-Anytime (TVA) system. Also, the present invention can provide an advanced targeting function.

### DESCRIPTION OF DRAWINGS

The above and other objects and features of the present invention will become apparent from the following description of the preferred embodiments given in conjunction with the accompanying drawings, in which:

FIG. 1 is a block diagram showing an entire adaptive broadcasting system in accordance with an embodiment of the present invention;

FIG. 2 is a block diagram illustrating the adaptive broadcasting system in detail in accordance with the embodiment of the present invention; and

FIG. 3 is a flowchart describing an adaptive broadcasting service providing process using Usage Environment Description (UED) information in accordance with an embodiment of the present invention.

### BEST MODE FOR THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on related art may blur the points of the present invention, the detailed description will not be provided herein. The preferred embodiments of the present invention will be described in detail hereinafter with reference to the attached drawings.

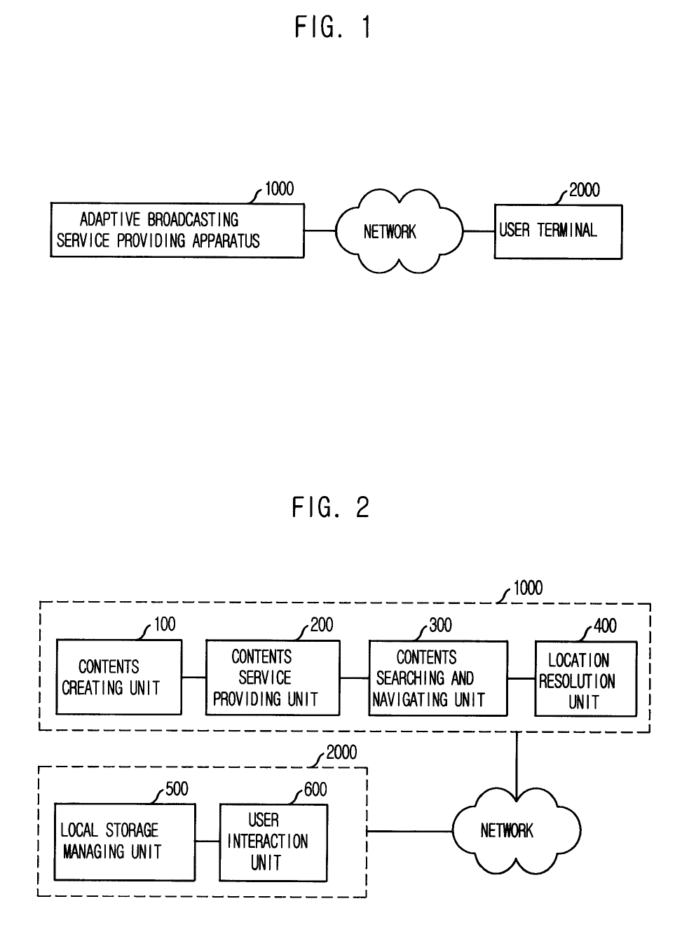

FIG. 1 is a block diagram showing an entire structure of an adaptive broadcasting system in accordance with an embodiment of the present invention.

As shown in FIG. 1, the adaptive broadcasting system of the present invention includes an adaptive broadcasting service providing apparatus 1000 and a user terminal 2000. The adaptive broadcasting service providing apparatus 1000 provides broadcasting contents including an audio/video (AV) program and a package, and an adaptive broadcasting service supporting a synchronizing function and a targeting function. The user terminal 2000 for consuming application services such as contents search, selection, acquisition, and consumption based on contents and contents-related metadata from the adaptive broadcasting service providing apparatus 1000, which are connected to a network including a broadcasting channel/bi-directional IP network.

FIG. 2 is a block diagram illustrating the adaptive broadcasting system in detail in accordance with the embodiment of the present invention.

As shown in FIG. 2, the adaptive broadcasting service providing apparatus 1000 includes a contents creating unit 100, a contents service providing unit 200, a contents searching and navigating unit 300 and a location resolution unit 400, and the user terminal 2000 includes a user interaction unit 600 and a local storage managing unit 500 and it may further include a contents presenting unit (not shown) and a rights managing and protecting unit (not shown). Functions of each constituent element are as follows.

The contents creating unit 100 creates an AV program and a package. A studio, an entertainment company, a Web designer, or a user adaptive contents producer can manage the package creation work.

The contents service providing unit 200 reorganizes contents and metadata, inserts metadata and transmits contents, and terrestrial, satellite and cable broadcasting companies, Web casters or portal service providers can manage the work.

The contents searching and navigating unit 300 is based on broadcasting metadata published in Electronic Program Guide (EPG) for available contents. A contents searching and navigating function returns a contents identifier (CRID) of contents selected by a user or automatically selected by a terminal.

The location resolution unit 400 determines a physical location of contents including a channel and broadcasting time from the CRID acquired from the contents searching and navigating unit 300.

The local storage managing unit 500 stores and manages broadcasting contents and metadata. The metadata can be managed in an Extensible Markup Language (XML) database (DB) or a relational DB. A function connecting metadata between a user and a service provider in bi-directional corresponds to providing user history information and user preference information from the user.

The user interaction unit 600 drives constituent elements based on a user input signal inputted from an input device of a user terminal, e.g., a key board, a remote controller, a mouse and a joystick.

The contents presenting unit (not shown) provides broadcasting contents and metadata to the user terminal such that a user can use.

The rights managing and protecting unit (not shown) protects interface between the constituent elements based on a proper protecting/managing policy, which is revealed in “Bimetadata delivery protection” ETSI TS 102 822-5-1/2 and ETSI TS 102 822-7.

The above-mentioned embodiment is an example of the adaptive broadcasting system in a complete bi-directional broadcasting environment.

A method for realizing the adaptive broadcasting system is largely divided into two based on a service environment. In a broadcasting environment having a sheer unidirectional broadcasting environment or a narrow-band bi-directional channel, only the contents creating unit and the contents service providing unit among the elements of the adaptive broadcasting system exist in the outside of the user terminal, e.g., Personal Digital Recorder (PDR), and all elements except the contents creating unit and the contents service providing unit make a user be able to consume desired contents through search, selection, location resolution and acquisition processes in the PDR.

Meanwhile, as described in the above embodiment, in a complete bi-directional broadcasting environment, the contents searching/navigating unit and the location resolution unit as well as the contents creating unit and the contents service providing unit among components of the adaptive broadcasting system can exist in the outside of the PDR. Therefore, the PDR includes only the user interaction unit, the contents presenting unit and the local storage managing unit, and makes a user be able to consume desired contents through search, selection, location resolution and acquisition processes through bi-directional connection to the contents service providing unit or the contents searching and navigating unit.

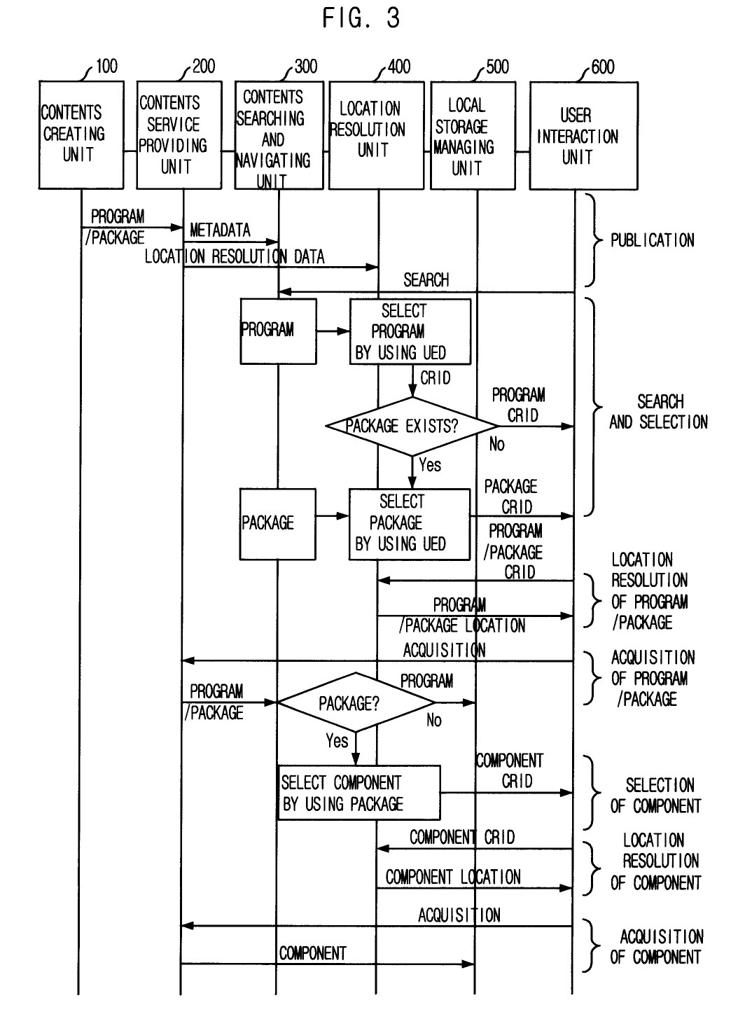

FIG. 3 is a flowchart describing an adaptive broadcasting service providing process using UED information in accordance with an embodiment of the present invention.

The adaptive broadcasting service providing process of the present invention basically includes the steps of publication, search, selection, location resolution, acquisition, view and finish.

When the AV program is provided, there are three operation scenarios. One is a case that the AV program is provided. Another is a case that the package is independent from the AV program. The other is a case that the package is dependent on the AV program based on whether provided contents are the AV program or the package, and whether the provided package is independent from or dependent on the AV program.

Publication

When an AV program is provided, the contents creating unit 100 creates the AV program. The contents service providing unit 200 publishes Content Reference Identifier (CRID) for identifying the AV program, attractive metadata of the AV program, schedule information and location resolution data.

Herein, the attractive metadata and schedule information of the AV program are described as program information (ProgramInformation) and program location (ProgramLocation) of a TVA-1 metadata schema.

The contents service providing unit 200 has a user be able to select an AV program that fits to an environment and preference of the user by publishing user environment and preference, in which the AV program is properly consumed, based on the UED information in ‘TargetingInformation’ which is a sub element of the program information.

When a package to be provided is independent from the AV program, the contents creating unit 100 creates only the package. The package is described based on a TVA-2 package schema and has a user be able to select a component which fits to an environment and preference of the user by publishing the proper user environment, in which components of the package can be properly consumed, and preference based on terminal information for describing biographic information and characteristic information of a terminal for describing a characteristic of the biographic information of the user in ‘TargetingInformation’, which is a sub element of a ‘ContentsDescription’ element.

The contents service providing unit 200 publishes the CRID for identifying the package, the package attractive metadata for inducing package consumption and approximate schedule information of the package. Also, location resolution data for describing when and where the package can be acquired is published. As described above, the attractive metadata and the schedule information of the package are described as the program information (ProgramInformation) and program location (ProgramLocation) of the TVA-1 metadata schema, just as a general AV program. The contents service providing unit 200 has a user be able to select a package which fits to an environment and preference of the user, by publishing proper user environment, in which the package is properly consumed, and preference based on biographic and terminal information of the present invention in ‘TargetingInformation’ i.e., a sub element of the ‘ProgramInformation’.

Meanwhile, when the package to be provided is dependent on the AV program, the contents creating unit 100 creates an AV program and a package dependent on the AV program. The contents service providing unit 200 publishes the CRID for identifying the AV program, attractive metadata of the AV program, schedule information, location resolution information, link information of the package connected to the AV program. Herein, the attractive metadata and the schedule information of the AV program are described as the program information and the program location of the TVA-1 metadata schema, and link information of the package connected to the AV program is described as a ‘RelatedMaterial’ element of the program information of the AV program. The contents service providing unit 200 has a user be able to select an AV program which fits to an environment and preference of the user by publishing user environment in which the AV program is properly consumed, and preference in ‘TargetingInformation’ i.e., a sub element of the program information based on the based on the biographic and terminal information. The homogeneous or heterogeneous contents service providing unit 200 publishes location resolution data for describing when and where the CRID for identifying the package and the package can be acquired.

Search

When the AV program is provided, the contents searching and navigating unit 300 provides the attractive metadata and the schedule information of the AV program to the user through the EPG. Also, the EPG provides proper user environment, in which the AV program can be properly consumed, and preference information which are described in the ‘TargetingInformation’ based on the biographic and terminal information.

The user grasps the attractive metadata of the AV program such as the title, synopsis and actors of the AV program provided by the EPG, and searches the AV program to be consumed in the contents searching and navigating unit 300 by comparing the proper user environment and preference with the user's own environment and preference.

When the provided package is independent from the AV program, the EPG provides the package attractive metadata and the package schedule information to the user. Also, the EPG provides user environment, in which the package is properly consumed, and preference information by applying the UED information of the present invention in the ‘TargetingInformation’ based on the biographic and terminal information of the present invention.

The user grasps the package attractive metadata such as a package title, synopsis and actors provided by the EPG, and searches the package to be consumed by comparing the user environment, in which the package can be properly consumed, and preference with the user's own environment and preference.

When the provided package is dependent on the AV program, the EPG provides link information of the package connected to the AV program with the attractive metadata and the schedule information of the AV program. Also, the EPG provides the proper user environment, in which the AV program is properly consumed, and preference information which were described in the ‘TargetingInformation’ based on the biographic and terminal information.

The user grasps the attractive metadata of the AV program such as the title, synopsis and actors of the AV program provided by the EPG, and searches the AV program to be consumed by comparing the proper user environment and preference, in which the AV program can be consumed, with the user's own environment and preference.

When the user searches the AV program or watches the program through the EPG, the user acquires information on the package connected to the AV program.

Selection

When an AV program is provided and the user selects the AV program preferred by the user in the EPG, the user acquires the CRID of the AV program from the contents searching and navigating unit 300.

When the provided package is independent from the AV program, the user acquires the CRID of the package in case that he selects the package preferred by the user in the EPG.

When the provided package is dependent on the AV program and the user selects the AV program preferred by the user in the EPG, the user acquires the CRID of the package connected to the AV program from a ‘RelatedMaterial’ element of ‘ProgramInformation’, which is the program information of the AV program.

Location Resolution

Both of the AV program and the package acquire physical location information of a real AV program and the package provided by the location resolution unit 400 through a location resolution mechanism from the CRID. The local storage managing unit 500 selects any one location among a plurality of contents locations including both channel and time informations to prevent collision during recording.

Acquisition

As an AV program or a package is acquired based on the selected location information including both channel information and time information.

When a package is acquired, the user grasps attractive metadata of the component of the package, and automatically or semiautomatically selects the entire or part of components to be consumed by comparing a user environment, in which the components can be properly consumed, and preference information with user's own environment and preference in ‘TargetingInformation’ i.e., the sub element of the ContentDescription elements based on UED information including the biographic and terminal information of the present invention.

When components are selected, physical location information providing an actual component from the location resolution unit 400 is acquired from the CRID of each component through a location resolution mechanism.

View

When an AV program is acquired, the AV program is outputted into a user screen so that the user can use the AV program. When the package is acquired, the package is provided to the user after all components selected by the user are acquired and screens are formed based on spatial/temporal relation information between components so that the user can use the package or the AV program.

Finishing

The AV program and package watching history information of the user is stored in a terminal and used to extract user's preference.

The biographic and terminal information of the UED information of the present invention will be described in detail hereinafter.

The ‘BioGraphicInformation’ incorporates ‘AgeGroup’. Since ‘AgeGroup’ can not be previously defined, the ‘AgeGroup’ is defined as ‘ControlledTermType’ of TVA. ‘OtherFamilyMember’ element is defined as ‘ControlledTermType’. The ‘AgeGroup’ is a term for describing an age of a user within a predetermined range and the ‘OtherFamilyMember’ is a term for describing family member of the user.

An Extensible Markup Language (XML) syntax of ‘BioGraphicInformation’ of the present invention is as follows:

```
<complexType name=“BioGraphicInformationType”>
<sequence>
<element name=“Name” type=“mpeg7:PersonNameType”
minOccurs=“0”/>
<element name=“Language” type=“tva2:LanguageType”
minOccurs=“0”/>
<element name=“BirthDate” type=“mpeg7:TimeType”
minOccurs=“0”/>
<element name=“Age” type=“mpeg7:unsigned8” minOccurs=“0”/>
<element name=“AgeGroup” type=“tva2:AgeRangeType”
minOccurs=“0”/>
<element name=“OtherFamilyMember”
type=“tva:ControlledTermType” minOccurs=“0”
  maxOccurs=“unbounded”/>
<element name=“Gender” minOccurs=“0”>
                  <simpleType>
                        <restriction base=“NMTOKEN”>
                              <enumeration value=“Male”/>
                              <enumeration value=“Female”/>
                        </restriction>
                  </simpleType>
            </element>
      </sequence>
</complexType>
```

Meanwhile, the terminal information of the UED information of the present invention includes ‘StorageType’ information.

‘StorageType’ describes a characteristic of a single storage unit and Moving Picture Experts Group (MPEG) 21 Document Library Services (DIA) can be used for describing a storage.

An XML syntax of the ‘StorageType’ is as follows:

```
<!-- ################################################ -->
<!-- Definition of Storage
        -->
<!-- ################################################ -->
<complexType name=“StorageType”>
                  <sequence>
                        <element name=“StorageCharacteristic”
      type=“dia:StorageCharacteristicsType”
                              minOccurs=“0”
maxOccurs=“unbounded”/>
                  </sequence>
</complexType>
```

Semantics of ‘StorageType’ is shown in Table 1:

TABLE 1

| Name | Definition |
|---|---|
| StorageType | Tool for describing a |
| | characteristic of the |
| | storage unit |
| StorageCharacteristic | It describes a |
| | characteristic of the |
| | storage unit. |

The XML syntax of ‘StorageCharacteristicsType’ is as follows:

```
<!-- ################################################ -->
<!-- Definition of StorageCharacteristics -->
<!-- ################################################ -->
<complexType name=“StorageCharacteristicsType”>
<attribute name=“inputTransferRate”
type=“nonNegativeInteger” use=“optional”/>
      <attribute name=“outputTransferRate”
type=“nonNegativeInteger”
      use=“optional”/>
      <attribute name=“size” type=“float” use=“optional”/>
      <attribute name=“writable” type=“boolean”
use=“optional”/>
</complexType>
```

Semantics of the terms used in ‘StorageCharacteristicsType’ is shown in Table 2:

TABLE 2

| Name | Definition |
|---|---|
| StorageCharacteristicsType | Tool for describing storage |
| | characteristic of terminal |
| inputTransferRate | It describes input transfer |
| | rate that storage can manage |
| | on a Mbytes basis |
| outputTransferRate | It describes output transfer |
| | rate that storage can accept |
| | on a Mbytes basis |
| Size | The size of storage is |
| | described on a Mbytes basis |
| Writable | It shows whether storage can |
| | record. |

An XML syntax of ‘TerminalInformationType’, which is a terminal information type, used after incorporating the ‘StorageType’ is as follows. A multi storage device is described in a single terminal based on a plurality of ‘StorageTypes’ in the ‘TerminalInformationType’.

```
<complexType name=“TerminalInformationType”>
<sequence>
<element name=“DecoderInformation”
type=“mpeg21:CodecCapabilityBaseType”
  minOccurs=“0” maxOccurs=“unbounded”/>
<element name=“EncoderInformation”
type=“mpeg21:CodecCapabilityBaseType”
  minOccurs=“0” maxOccurs=“unbounded”/>
<element name=“DisplayInformation”
type=“mpeg21:DisplayType” minOccurs=“0”
  maxOccurs=“unbounded”/>
<element name=“AudioInformation”
type=“mpeg21:AudioOutputType” minOccurs=“0”
  maxOccurs=“unbounded”/>
<element name=“InteractionInputInformation”
type=“mpeg21:UserInteractionInputType”
  minOccurs=“0” maxOccurs=“unbounded”/>
<element name=“StorageInformation”
type=“mpeg21:StorageType” minOccurs=“0”
  maxOccurs=“unbounded”/>
<element name=“SystemInformation”
type=“tva2:SystemInformationType” minOccurs=“0”/>
<element name=“HardwareManufacturer”
type=“tva2:HardwareManufacturerType”
  minOccurs=“0”/>
<element name=“TerminalType” type=“tva:ControlledTermType”
minOccurs=“0”/>
      </sequence>
<attribute name=“terminalInformationId”
type=“tva:TVAIDType” use=“optional” />
</complexType>
```

To summarize the characteristics of the biographic information and terminal information in the UED information of the present invention described above, the ‘BioGraphicInformation’ includes the ‘AgeGroup’ and the ‘OtherFamilyMember’ as the ‘ControlledTermTypes’ and the ‘TerminalInformation’ is described by including the ‘StoragesType’.

As described in detail, the present invention can be embodied as a program and stored in a computer-readable recording medium, such as CD-ROM, RAM, ROM, a floppy disk, a hard disk and a magneto-optical disk. Since the process can be easily implemented by those skilled in the art of the present invention, further description will not be provided herein.

While the present invention has been described with respect to certain preferred embodiments, it will be apparent to those skilled in the art that various changes and modifications may be made without departing from the scope of the invention as defined in the following claims.

### INDUSTRIAL APPLICABILITY

The technology of the present invention is applied to a TV-Anytime (TVA) system.

What is claimed is:

1. An adaptive broadcasting service providing apparatus using Usage Environment Description (UED) information for providing a targeting function for selecting an audio/video (AV) program, a package or components of the package based on a consumption environment and user preference, in an adaptive broadcasting system providing broadcasting contents including AV programs and packages to a user terminal, comprising:
a contents providing means for publishing and providing the broadcasting contents and metadata including the UED information to the user terminal; and
a contents searching means for providing contents identification information corresponding to a search and selection signal inputted from the user terminal,
wherein the UED information describes a consumption environment of the contents and includes:
biographic information for describing characteristics of user's biographic information; and
terminal information for describing characteristic information of the user terminal.

2. The apparatus as recited in claim 1, wherein the contents providing means, includes:
a contents creating unit for creating targeting information using the biographic and terminal information, and creating metadata describing a proper user environment, in which the components of a package are properly consumed, and user preference.

3. The apparatus as recited in claim 2, wherein when a package independent from the AV program is provided, the contents creating unit creates only the package, or when a package dependent on the AV program is provided, the contents creating unit creates the AV program and the package.

4. The apparatus as recited in claim 1, wherein the contents searching means provides metadata including the UED information based on Electronic Program Guide (EPG) so that the user can search the AV program or the package.

5. The apparatus as recited in claim 4, wherein the contents searching means provides functions that the user terminal grasp the AV program or package information based on the EPG, and searches for AV program or the package to be consumed by comparing the proper user environment, in which the AV program or the package can be properly consumed, and preference with the user's own environment and preference based on metadata including the UED information.

6. The apparatus as recited in claim 1, wherein the biographic information includes:
age group information for describing an age of the user; and
family member information for describing family member of the user.

7. The apparatus as recited in claim 6, wherein the age group and the family member information are ‘ControlledTermType’ of TVA.

8. The apparatus as recited in claim 7, wherein the biographic information is described by including an Extensible Markup Language (XML) syntax:
<complexType name=“BioGraphicInformationType”>
<sequence>
<element name=“Name” type=“mpeg7:PersonNameType”
minOccurs=“0”/>
<element name=“Language” type=“tva2:LanguageType”
minOccurs=“0”/>
<element name=“BirthDate” type=“mpeg7:TimeType”
minOccurs=“0”/>
<element name=“Age” type=“mpeg7:unsigned8” minOccurs=“0”/>
<element name=“AgeGroup” type=“tva2:AgeRangeType”
minOccurs=“0”/>
<element name=“OtherFamilyMember”
type=“tva:ControlledTermType” minOccurs=“0”
maxOccurs=“unbounded”/>
<element name=“Gender” minOccurs=“0”>

9. The apparatus as recited in claim 1, wherein the terminal information includes storage information for describing a characteristic of a storage unit.

10. The apparatus as recited in claim 9, wherein the storage information is described by StorageType expressed as an XML syntax:
```
<complexType name=“StorageType”>
            <sequence>
                  <element name=“StorageCharacteristic”
                        type=“dia:StorageCharacteristicsType”
                        minOccurs=“0” maxOccurs=“unbounded”/>
            </sequence>
</complexType>
```

11. An adaptive broadcasting service providing method using Usage Environment Description (UED) information for providing a targeting function for selecting an Audio video (AV) program, a package or components of the package based on a user consumption environment and preference, in an adaptive broadcasting system providing broadcasting contents including AV programs and packages to a user terminal, comprising the steps of:
a) publishing metadata including the broadcasting contents and the UED information to the user terminal;
b) providing contents identification information corresponding to a search and selection signal transmitted from the user terminal;
c) determining physical location of the broadcasting contents based on the contents identification information and providing location information; and
d) providing the broadcasting contents based on the location information,
wherein the UED information describes a consumption environment of the contents and includes:
biographic information for describing characteristics of user's biographic information; and
terminal information for describing characteristic information of the user terminal.

12. The method as recited in claim 11, further comprising the steps of:
e) creating targeting information using the biographic and terminal information, and creating metadata describing a proper user environment, in which the components of a package are properly consumed, and user preference.

13. The method as recited in claim 11, wherein the biographic information includes:
age group information for describing an age of the user; and
family member information for describing family member of the user.

14. The method as recited in claim 11, wherein the family member information is ControlledTermType of TV-Anytime (TVA).

15. The method as recited in claim 11, wherein the biographic information is described by including the XML syntax:
<complexType name=“BioGraphicInformationType”>
<sequence>
<element name=“Name” type=“mpeg7:PersonNameType”
minOccurs=“0”/>
<element name=“Language” type=“tva2:LanguageType”
minOccurs=“0”/>
<element name=“BirthDate” type=“mpeg7:TimeType”
minOccurs=“0”/>
<element name=“Age” type=“mpeg7:unsigned8” minOccurs=“0”/>
<element name=“AgeGroup” type=“tva2:AgeRangeType”
minOccurs=“0”/>
<element name=“OtherFamilyMember”
type=“tva:ControlledTermType” minOccurs=“0”
maxOccurs=“unbounded”/>
<element name=“Gender” minOccurs=“0”>

16. The method as recited in claim 11, wherein the terminal information includes storage information for describing a characteristic of a storage unit.

17. The method as recited in claim 16, wherein the storage information is expressed as the XML syntax:
```
<complexType name=“StorageType”>
            <sequence>
                  <element name=“StorageCharacteristic”
                        type=“dia:StorageCharacteristicsType”
                        minOccurs=“0” maxOccurs=“unbounded”/>
            </sequence>
</complexType>
```

18. An adaptive broadcasting system using Usage Environment Description (UED) information, comprising:
an adaptive broadcasting service providing apparatus for providing broadcasting contents including audio/video (AV) program and a package, and an adaptive broadcasting service supporting a synchronizing function and a targeting functions based on UED information; and
a user terminal for receiving and consuming broadcasting contents and metadata from the adaptive broadcasting service providing apparatus,
wherein the UED information describes a consumption environment of the contents and includes:
biographic information for describing characteristics of user's biographic information; and
terminal information for describing characteristic information of the user terminal.

19. The system as recited in claim 18, wherein the adaptive broadcasting service providing apparatus includes:
a contents providing means for publishing and providing the metadata including the UED information to the user terminal; and
a contents searching means for providing contents identification information corresponding to a search and selection signal transmitted from the user terminal.

20. The system as recited in claim 18, wherein the user terminal includes:
a user interaction unit for searching, selecting and acquiring the broadcasting contents based on the metadata including the UED information, and driving components of the user terminal to correspond to the user input signal;
a local storage managing unit for storing and managing the broadcasting contents and the metadata; and
a contents presenting unit for presenting the broadcasting contents and the metadata such that a user can watch.

21. The system as recited in claim 18, wherein the user terminal receives the package, grasps attractive metadata of components of the package, and automatically or semiautomatically selects entire or part components to be consumed by comparing a user environment, in which the components are properly consumed, and user preference information based on the UED information.

22. The system as recited in claim 18, wherein the biographic information includes:
age group information for describing an age of the user; and
family member information for describing family member of the user.

23. The system as recited in claim 18, wherein the terminal information includes storage information for describing a characteristic of a storage unit.

24. A user terminal for receiving broadcasting contents including an audio/video (AV) program and a package based on Usage Environment Description (UED) in an adaptive broadcasting system for providing an adaptive broadcasting service supporting a synchronizing function and a targeting function from an adaptive broadcasting service providing apparatus to the user terminal, comprising:
a user interaction unit for searching, selecting and acquiring the broadcasting contents based on metadata including the UED information published from the adaptive broadcasting service providing apparatus;
a local storage managing unit for storing and managing the acquired broadcasting contents and metadata; and
a contents presenting unit for presenting the broadcasting contents and the metadata such that a user can watch,
wherein the UED information describes a consumption environment of the contents includes:
biographic information for describing characteristics of user's biographic information; and
terminal information for describing characteristic information of the user terminal.

25. The user terminal as recited in claim 24, wherein the user interaction unit grasps attractive metadata of components of the package, compares a user environment, in which the described components are properly consumed, and preference information with its own environment and preference based on UED information, and automatically or semiautomatically selects entire or part components to be consumed.

26. The user terminal as recited in claim 24, wherein the biographic information includes:
age group information for describing an age of the user; and
family member information for describing family member of the user.

27. The user terminal as recited in claim 24, wherein the terminal information includes storage information for describing a characteristic of a storage unit.

28. A metadata scheme, comprising:
UED information for a TV-Anytime (TVA) broadcasting service,
wherein the UED information includes:
biographic information for describing a characteristic of user's biographic information; and
terminal information for describing characteristic information of the user terminal.
